(19) United States
(12) Patent Application Publication
(10) Pub. No.: US 2004/0200687 A1
(43) Pub. Date: Oct. 14, 2004

(54) Pressure plate for a friction clutch

(75) Inventors: Thomas Rudolf, Schweinfurt (DE); Klaus Fischer, Hassfurt (DE); Jurgen Loibersbeck, Grafenrheinfeld (DE); Werner Selzam, Wipfeld (DE); Jan Wittholz, Schonungen (DE); Arnold Huisjes, Schweinfurt (DE)

Correspondence Address: COHEN, PONTANI, LIEBERMAN & PAVANE, 551 FIFTH AVENUE, SUITE 1210, NEW YORK, NY, 10176, US

(73) Assignee: Sachs Race Engineering GmbH

(21) Appl. No.: 10/794,380

(22) Filed: Mar. 5, 2004

(30) Foreign Application Priority Data
Mar. 7, 2003 (DE) 103 09 939.5

(51) Int. Cl. F16D 13/70

(52) U.S. Cl. 192/107 R

(57) ABSTRACT

A pressure plate for a friction clutch includes a ring-like pressure plate body with a pressure surface on a first axial side for exerting pressure on friction elements, and at least one support element on a second axial side opposite the first axial side. The at least one support element is a separate element from the pressure plate. The at least one support element is arranged for receiving a pressure from a force-exerting arrangement such as a diaphragm spring.

### BACKGROUND OF THE INVENTION

1. Field of the Invention

The present invention pertains to a pressure plate for a friction clutch.

2. Description of the Related Art

A friction clutch of the type used, for example, in the field of racing or in motor vehicles with high-power or high-torque prime movers is shown in FIG. 2 of the present application. The friction clutch 30, also referred to as a multi-disk clutch, has an essentially ring-shaped housing 32 rotatable about an axis of rotation and having one axial side that is permanently connected to a housing cover 34 or designed as an integral part of the housing cover 34. The other axial side of the ring-shaped housing 32 is connectable to a flywheel by threaded bolts which pass through openings 36. A set of gear-like teeth 38 are arranged on the inner circumferential surface of the housing 32 extending in a direction parallel to that of the axis of rotation A. Several friction elements 40 (hereafter referred to as outer disks 40) include corresponding gear-tooth formations engaging the gear-like teeth 38 so that the outer disks 40 are prevented from rotating relative to the housing 32, but are axially displaceable relative to the housing 32 in a direction parallel to the axis of rotation A. Friction elements 42 (hereafter referred to as inner disks 42) are alternately interleaved between the outer disks 40. These inner disks 42 have gear-tooth formations on their radially inner surface and engage with a corresponding, axially oriented gear-tooth formation 44 on a hub 46 so that the inner disks 42 are prevented from rotating relative to the hub 46, but are axially displaceable relative to the hub 46 in the direction parallel to the axis A. Like the outer disks 40, a pressure plate 10 is also connected nonrotatably to the housing 32 with the freedom to shift in the direction parallel to the axis A. The pressure plate 10 acts by way of one of the outer disks 40 on the disk package consisting of the outer disks 40 and the inner disks 42, so that, in the engaged state, torque can be transmitted between the housing 32 and the hub 46 by the friction-locking connection thus established between the inner and outer disks 40, 42.

A force-exerting arrangement, designed here as a diaphragm spring 50, acts on a blade-like elevation 48 on the pressure plate 40. This spring 50 is mounted on or held relative to the housing 32 or the housing cover 34 by a connecting device such as, for example, spacer bolts 52. The spring 50 is thus supported so that it generates the reaction force required for producing the engaged state.

When clutches such as friction clutch 30 shown in FIG. 2 are used in the racing field or when they are used in the area of luxury vehicles, very high-quality materials are generally used for the individual components of the friction clutch because of the loads which occur in vehicles of these types. Thus, for example, carbon materials are used for the various friction elements, and steel and titanium alloys are used for the various housing parts and the pressure plate. The use of these types of high-quality materials, however, also leads to a corresponding increase in cost.

### SUMMARY OF THE INVENTION

It is an object of the present invention to provide a friction clutch which reduces as much as possible the need to replace the worn-out parts of the friction clutch or of a pressure plate of the friction clutch.

According to the present invention, this task is accomplished by a pressure plate for a friction clutch comprising a ring-like pressure plate body rotatable about an axis of rotation and having first and second axial sides, the first axial side includes a pressure surface which acts on friction elements and the second axial side includes at least one support element connected to the ring-like pressure plate, wherein the at least one support element and the ring-like pressure plate are separate components. The at least one support element is arranged on the ring-like pressure plate such that a force-exerting arrangement such as a diaphragm spring exerts pressure on the pressure plate through the at least one support element.

Very severe loads develop in the area of mutual contact between the pressure plate and the force-exerting arrangement causing comparatively heavy wear on the pressure plate in this area. Wear in this area, however, requires that the worn-out component must eventually be replaced so that the clutch can continue to function as required. Replacing the pressure plate has the effect of compensating for the wear of the friction disks. That is, a pressure plate of greater thickness compensates for the loss of thickness by the friction disks. In the state of the art shown in FIG. 2, the entire pressure plate must be replaced for this purpose. However, the pressure plate according to the present invention allows the pressure plate body to remain in the clutch and for only the at least one support element to be replaced, the at least one support element having been worn down by the action of the force-exerting arrangement. The replacement work in the clutch according to the present invention can be done much more easily than in the prior art clutch. Furthermore, the cost of renewing this type of pressure plate, i.e., a friction clutch with this type of pressure plate, is also significantly reduced by the present invention.

To reliably hold the at least one support element in place on the pressure plate body, a recess is defined in the pressure plate body on the second axial side. The at least one support element is at least partially accommodated in the recess.

The at least one support element may also be held in the assigned recess so that it is prevented from moving in the circumferential direction.

The support element may be provided with a projection against which the force-exerting arrangement is supported such that the at least one support element interacts effectively with the force-exerting arrangement.

To avoid imbalances and to maintain the simplest possible design, the at least one support element may be designed as a ring.

The pressure plate body may comprise steel or a titanium alloy. In a preferred embodiment, the at least one support element is made of the same material as that of the pressure plate body. This allows the same thermal expansion conditions to be present in the area of the pressure plate body and in the area of the at least one support element, thereby avoiding warping and torsional stresses within the pressure plate itself which could be caused by thermal expansion of components having different thermal expansion coefficients.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a longitudinal cross-sectional view of a pressure plate according to the present invention; and

FIG. 2 is a longitudinal cross section through a prior art multi-disk clutch.

### DETAILED DESCRIPTION OF THE PRESENTLY PREFERRED EMBODIMENTS

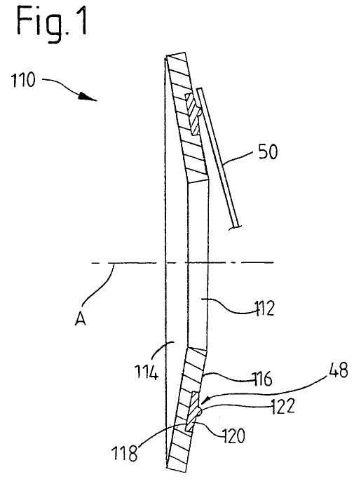

FIG. 1 shows a pressure plate 110 which is suitable for use in the multi-disk clutch 30 shown in FIG. 1.

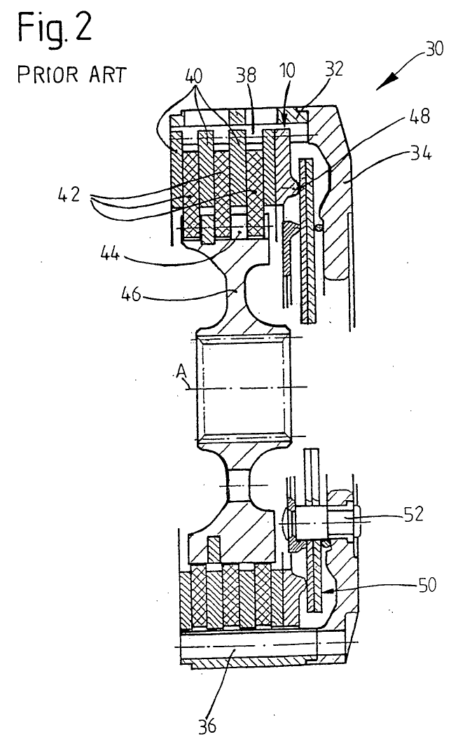

The pressure plate 110 includes a ring-like pressure plate body 112 having a first axial side 114 and a second axial side 116. The first axial side 114 of the pressure plate body 112 exerts force, when in the engaged state, on the friction elements, i.e., for example, on the disks 40, 42 shown in FIG. 2 to bring them into frictional contact with each other. The second axial side 116 includes a circumferential recess 118 which is positioned centrally with respect to the axis of rotation or axis of symmetry A of the pressure plate body 112. A support element 120 is inserted into the recess 118. The support element 120 is accommodated essentially completely in this recess 118 and has a support projection 122, providing the blade-like area 48 visible in FIG. 2, projecting outward from the second axial side 116 of the pressure plate body 112. The diaphragm spring 50 or some other type of force-exerting arrangement exerts force upon the support projection 122. FIG. 1 illustrates that this support projection 122 of the pressure plate 110 designed according to the present invention has a dome-like or circular contour in cross section to ensure that the pressure plate and the diaphragm spring 50 interact with each other properly.

The rotation of the ring-like support element 120 relative to the pressure plate body 112 may be prevented by providing additional recesses or elevations, for example, at various points in the bottom area of the recess 118, which recesses or elevations positively engage with corresponding formations on the support element 120.

The pressure plate body 112 and the support element 120 are preferably made of the same material such as, for example, steel or titanium alloy. This offers the advantage that, even when these two components 112, 120 are heated, the support element 120, which otherwise is seated loosely in the recess 118, will expand and contract in the same way as the pressure plate body 112. The occurrence of torsional stresses between these two components may thus be avoided. To prevent the support element 120 from jumping out of the recess 118 in the disengaged state, i.e., the state in which the diaphragm spring 50 has moved away from the support element 120, care should be taken to ensure that the depth of the recess 118 or the depth to which the support element 120 extends into this recess 118 is greater than the axial distance which the support element 120 can travel relative to the pressure plate body 112 when no force is acting on it.

FIG. 1 further shows that the pressure plate body 112 has a slightly conical or umbrella-like shape, so that the radially inner area of the pressure plate body 112 is farther away from the directly adjacent disk than the radially outer area of the pressure plate body 112. In this way, an axial elasticity may be incorporated into the pressure plate 110, which can takes over the function of the lining springs of conventional clutch disks. As a result of this slightly conical or umbrella-like design of the pressure plate body 112, the support element 120 also acquires a corresponding shape.

It should be pointed out that it is obviously not necessary in the pressure plate 110 according to the present invention to use a support element 120 which extends continuously all the way around the circumference. It is also possible in principle to provide several separate support elements, designed in the form of, for example, segments of a circle, and to insert them in corresponding recesses at several positions around the circumference. It is advantageous to use a support element in the shape of a ring, however, because it avoids imbalances and provides a support projection 122 which extends continuously all the way around the circumference.

Even though it is obvious, it should be pointed in conclusion that the pressure plate according to the invention can also be used in friction clutches of other designs as well such as, for example, in friction clutches with a pressure plate, a clutch disk, and a flywheel; in dual clutches; and in multi-plate clutches.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A pressure plate for a friction clutch, comprising:
a ring-like pressure plate body having first and second axial sides, said first axial side being opposite from said second axial side, wherein said first axial side comprises a pressure surface for exerting pressure on friction elements; and
at least one support element comprising a separate component from said ring-like pressure plate body and arranged for receiving pressure from a force-exerting arrangement of the friction clutch.

2. The pressure plate of claim 1, wherein a recess is defined on said second axial side of said pressure plate body in which said at least one support element is at least partially accommodated.

3. The pressure plate of claim 2, wherein said one support element is held in said recess such that said at least one support element is prevented from moving in the circumferential direction relative to said pressure plate body.

4. The pressure plate of claim 1, wherein said at least one support element comprises a support projection for receiving pressure from the force-exerting arrangement of the friction clutch.

5. The pressure plate of claim 1, wherein said support element is an annular-shaped element.

6. The pressure plate of claim 1, wherein said pressure plate body is made of steel or a titanium alloy.

7. The pressure plate of claim 1, wherein said at least one support element and said pressure plate body are made of the same material.
